(19) United States
(12) Patent Application Publication
(10) Pub. No.: US 2023/0402725 A1
(43) Pub. Date: Dec. 14, 2023

(54) BATTERY

(71) Applicant: Samsung SDI Co., Ltd., Yongin-si (KR)

(72) Inventor: Sanghun Park, Yongin-si (KR)

(21) Appl. No.: 18/207,030

(22) Filed: Jun. 7, 2023

(30) Foreign Application Priority Data
Jun. 8, 2022 (KR) 10-2022-0069548

(51) Int. Cl. H01M 50/54; H01M 50/524; H01M 50/533

(52) U.S. Cl. CPC H01M 50/54; H01M 50/524; H01M 50/533

(57) ABSTRACT

A battery includes: a core cell having a first surface and a second surface opposite to the first surface; an electrode tab including a rim portion forming an accommodation space, the rim portion being conductively connected to an electrode surface formed by at least one of the first surface and the second surface of the core cell, the accommodation space being surrounded along its periphery by the rim portion on the electrode surface; and a conductive compression layer between the electrode surface and the electrode tab to form a conductive connection. The conductive compression layer includes an insulating resin and conductive particles suspended in the insulating resin, and the insulating resin is accommodated in the accommodation space.

### CROSS-REFERENCE TO RELATED APPLICATION

This application claims priority to and the benefit of Korean Patent Application No. 10-2022-0069548, filed on Jun. 8, 2022, in the Korean Intellectual Property Office, the entire disclosure of which is incorporated herein by reference.

### BACKGROUND

### 1. Field

Aspects of embodiments of the present disclosure relate to a battery.

### 2. Description of the Related Art

Generally, secondary batteries may be (re)charged and discharged, unlike primary batteries that are not designed to be charged. Secondary batteries may be used as energy sources for mobile devices, electric vehicles, hybrid vehicles, electric bicycles, uninterruptible power supplies, etc. and may be used in the form of a single battery or in the form of a module in which a plurality of batteries are connected to each other into a single unit depending on the type of external devices to be applied to.

### SUMMARY

An embodiment of the present disclosure provides a battery having improved electrical connection reliability between a core cell and an electrode tab forming charging and discharging paths of the core cell and facilitates a connection process.

Additional aspects and features of the present disclosure will be set forth, in part, in the description which follows and, in part, will be apparent from the description or may be learned by practice of the presented embodiments of the present disclosure.

According to an embodiment of the present disclosure, a battery includes: a core cell having a first surface and a second surface opposite to the first surface; an electrode tab including a rim portion forming an accommodation space, the rim portion being conductively connected to an electrode surface formed by at least one of the first surface and the second surface of the core cell, the accommodation space being surrounded along its periphery by the rim portion on the electrode surface; and a conductive compression layer between the electrode surface and the electrode tab to form a conductive connection. The conductive compression layer includes an insulating resin and conductive particles suspended in the insulating resin, and the insulating resin is accommodated in the accommodation space.

The electrode tab may further include a protrusion portion extending in a first direction from the rim portion on the electrode surface to a position outside the electrode surface.

The rim portion may have a first width in the first direction and a second width in a second direction crossing the first direction, and the first width may be greater than the second width.

The electrode tab may include a first electrode tab and a second electrode tab. The first electrode tab may be conductively connected to a first electrode surface formed by the first surface, and the second electrode tab may be conductively connected to a second electrode surface formed by the second surface. The first electrode tab may include a first protrusion portion extending in a first direction from the first electrode surface to a position outside the first electrode surface, and the second electrode tab may include a second protrusion portion extending in the first direction from the second electrode surface to a position outside the second electrode surface.

The first protrusion portion may extend from a first rim portion on the first electrode surface toward the second protrusion portion along a side surface of the core cell extending between the first surface to the second surface.

The second protrusion portion may extend parallel to the second electrode surface from a second rim portion on the second electrode surface.

A first rim portion of the first electrode tab on the first electrode surface may have a first width in the first direction and a second width in a second direction crossing the first direction, and the first width may be greater than the second width. A second rim portion of the second electrode tab on the second electrode surface may have a fourth width in the second direction and a third width in the first direction, and the fourth width may be greater than the third width.

The second direction may be perpendicular to the first direction.

A first rim portion of the first electrode tab on the first electrode surface may include a long-side portion extending in the first direction and a short-side portion extending in a second direction crossing the first direction to form a rectangular border shape.

The conductive compression layer may include a first conductive compression layer conductively connecting the first electrode tab to the first electrode surface, and the first conductive compression layer may have a rectangular sheet shape with a contour following the first rim portion and may cover a first accommodation space surrounded along its periphery by the first rim portion.

A second rim portion of the second electrode tab on the second electrode surface may include a front strip having an arc shape following a circular border of the second electrode surface, a rear strip extending in one direction along a second direction crossing the first direction, and side strips connecting both ends of the front strip to both ends of the rear strip.

The side strips may respectively extend from the ends of the rear strip at an obtuse angle with respect to the rear strip to connect to both ends of the front strip.

The conductive compression layer may include a second conductive compression layer conductively connecting the second electrode tab to the second electrode surface, and the second conductive compression layer may have a sheet shape with a contour following the second rim portion and may cover a second accommodation space surrounded along its periphery by the second rim portion.

The second conductive compression layer may have a round shape or a plurality of bends following the front strip of the second rim portion.

The rim portion of the electrode tab may form a single continuous accommodation space on the electrode surface.

The electrode tab may further include a pattern portion extending inside the rim portion to form a plurality of accommodation spaces surrounded by the rim portion.

The electrode tab may further include a protrusion portion extending from the rim portion on the electrode surface in a first direction to a position outside the electrode tab, and the pattern portion may include a strip extending in one of the first direction and a second direction crossing the first direction and may form a plurality of accommodation spaces elongated in one of the first direction and the second direction.

The pattern portion may include a plurality of strips extending in a first direction and a second direction crossing the first direction to form a plurality of accommodation spaces arranged in the first direction and the second direction.

The pattern portion may include a plurality of strips between accommodation spaces formed in unit shapes, and uniform unit shapes forming the accommodation spaces may be repeated in a first direction and a second direction crossing the first direction.

The plurality of strips forming the pattern portion may be arranged alternately with the accommodation spaces formed in the unit shapes in the first direction and the second direction.

The unit shapes may be spaced apart from a boundary of the electrode tab, and the accommodation spaces may be closed by the electrode tab.

The unit shapes may contact the boundary of the electrode tab, and the accommodation spaces may be open to the outside of the electrode tab.

The unit shapes may be arranged in rows in one of the first direction and the second direction, and the unit shapes of columns adjacent to each other in one of the second direction and the first direction may be at the same position.

The unit shapes may be arranged in rows in one of the first direction and the second direction, and the unit shapes of columns adjacent to each other in one of the second direction and the first direction may be arranged at positions staggered from each other.

### BRIEF DESCRIPTION OF THE DRAWINGS

The above and other aspects and features of the present disclosure will be more apparent from the following description, taken in conjunction with the accompanying drawings, in which:

FIG. 1 is a perspective view of a battery according to an embodiment of the present disclosure;

FIG. 2 is an exploded perspective view of the battery illustrated in FIG. 1;

FIG. 3A is a partially exploded perspective view of a top of the battery illustrated in FIG. 1;

FIG. 3B is a partially exploded perspective view of a bottom of the battery illustrated in FIG. 1;

FIG. 4 is a cross-sectional view taken along the line A-A′ of FIG. 3A;

FIGS. 5 to 8 are perspective views illustrating various embodiments of the first electrode tab illustrated in FIG. 3A; and

FIGS. 9 to 12 are perspective views illustrating various embodiments of the second electrode tab illustrated in FIG. 3B.

### DETAILED DESCRIPTION

Reference will now be made, in detail, to embodiments, examples of which are illustrated in the accompanying drawings. The described embodiments may have different forms and should not be construed as being limited to the descriptions set forth herein. Accordingly, embodiments are merely described below, by referring to the figures, to explain aspects and features of the present description.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, a battery according to embodiments of the present disclosure will be described with reference to the accompanying drawings.

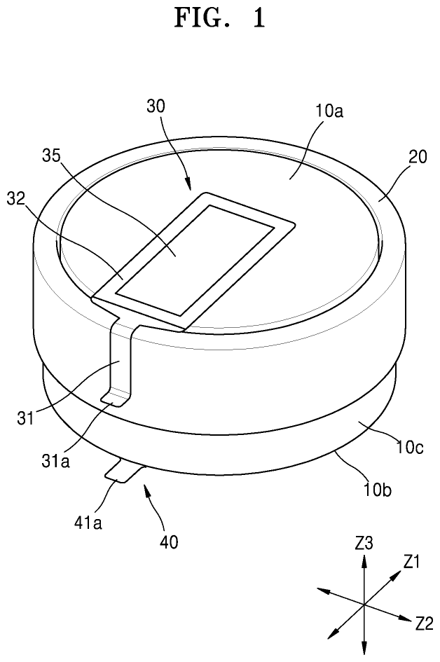

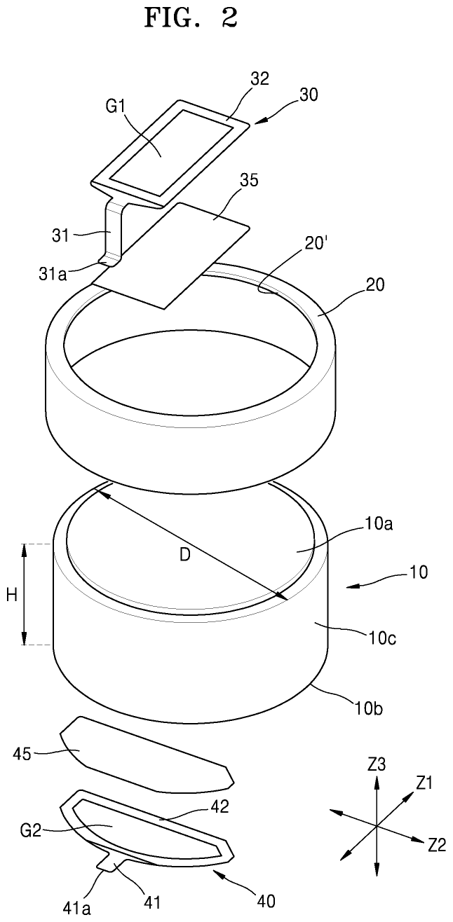

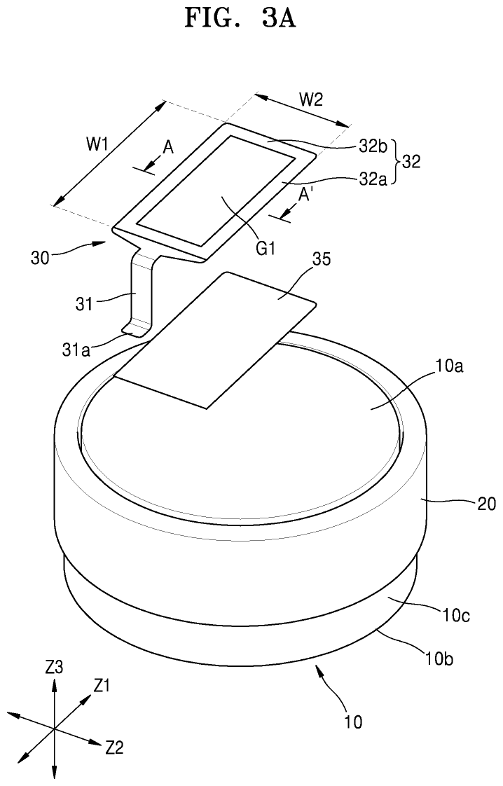

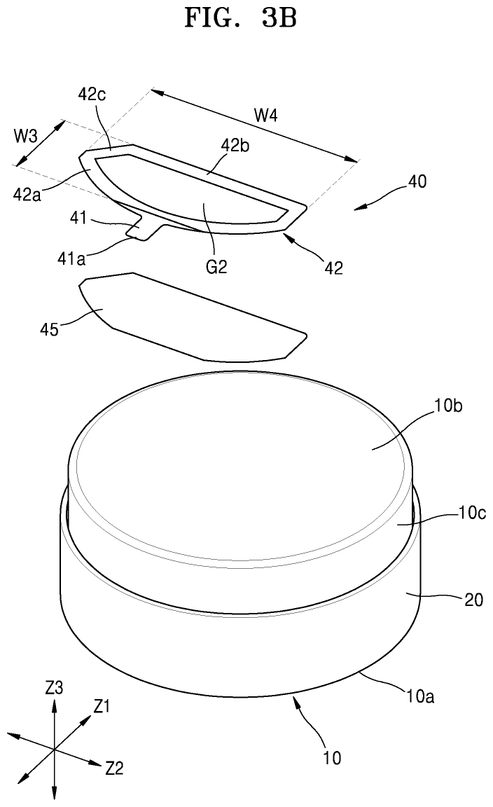

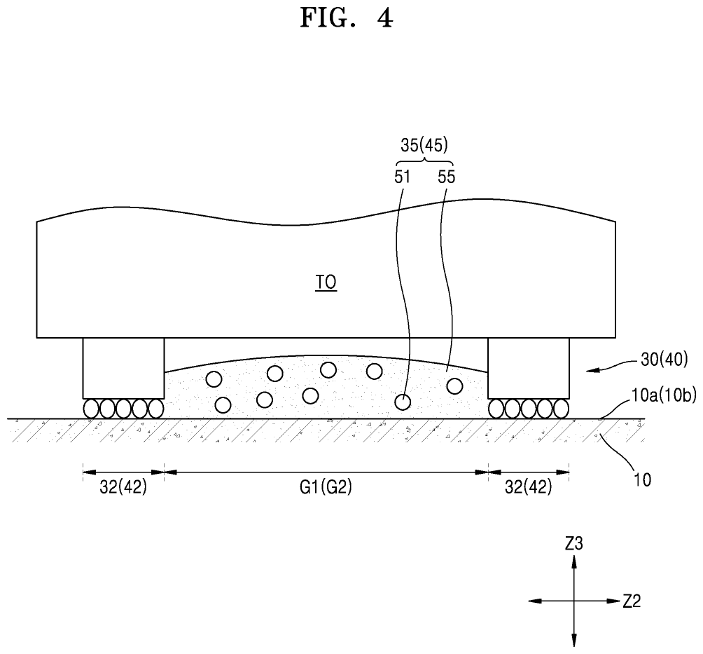

FIG. 1 is a perspective view of a battery according to an embodiment of the present disclosure. FIG. 2 is an exploded perspective view of the battery illustrated in FIG. 1. FIG. 3A is an exploded perspective view of a top of the battery illustrated in FIG. 1 and illustrates an electrical connection and physical coupling between a core cell and a first electrode tab having a conductive compression layer interposed therebetween. FIG. 3B is an exploded perspective view of a bottom of the battery illustrated in FIG. 1 and illustrates an electrical connection and physical coupling between a core cell and a second electrode tab having a conductive compression layer interposed therebetween. FIG. 4 is a cross-sectional view taken along the line A-A′ of FIG. 3A.

Referring to FIGS. 1 to 4, a battery according to an embodiment of the present disclosure may include a core cell 10 having first and second surfaces 10a and 10b opposite to each other, rim portions 32 and 42 respectively conductively connected the first and second surfaces 10a and 10b that are electrode surfaces, first and second electrode tabs 30 and 40 respectively forming accommodation spaces G1 and G2 surrounded by the respective rim portions 32 and 42 on the first and second surfaces 10a and 10b, respectively, and first and second conductive compression layers 35 and 45 that are respectively between the first surface 10a and the first electrode tab 30 and between the second surface 10b and the second electrode tab 40 to form conductive connections therebetween. Each of the first and second conductive compression layers 35 and 45 includes conductive particles 51 and an insulating resin 55 accommodating the conductive particles 51 (e.g., the conductive particles 51 may be suspended in the insulating resin 55), and the accommodation spaces G1 and G2 may each accommodate the respective insulating resin 55.

The core cell 10 may have the first and second surfaces 10a and 10b opposite to each other and a side surface 10c connecting (or extending between) the first surface 10a to the second surfaces 10b. For example, the core cell 10, according to an embodiment of the present disclosure, may have a circular first surface 10a, a circular second surface 10b, and a rounded side surface 10c having a shape of a circumferential surface that connects the first surface 10a and the second surface 10b to each other.

In one embodiment of the present disclosure, the first and second surfaces 10a and 10b may respectively be first and second electrode surfaces 10a and 10b having different polarities. In such an embodiment, the first and second electrode tabs 30 and 40 may be respectively conductively connected to the first and second surfaces 10a and 10b. The first and second surfaces 10a and 10b may be substantially flat such that respective conductive connections with the first and second electrode tabs 30 and 40 may be smoothly achieved. For example, the first and second surfaces 10a and 10b may be flat on a plane formed by first and second directions Z1 and Z2. For reference, the first and second electrode tabs 30 and 40, which are respectively on the first and second surfaces 10a and 10b, may respectively include protrusion portions 31 and 41 extending in the first direction Z1. The first and second surfaces 10a and 10b may each be flat on a plane formed in the second direction Z2 crossing the first direction Z1 and may be at the same level in a third direction Z3 crossing the first and second directions Z1 and Z2.

In one embodiment of the present disclosure, the core cell 10 may have a slimmed cylindrical shape formed with a height H that is smaller than a diameter D of the circular first surface 10a or a diameter of the circular second surface 10b. In one embodiment of the present disclosure, the height H of the core cell 10 may correspond to a dimension of the core cell 10 in the third direction Z3.

In one embodiment of the present disclosure, the core cell 10 may have a relatively slimmer shape with a smaller height H between the first and second surfaces 10a and 10b than the diameter D of the first surface 10a or the diameter of the second surface 10b. In one embodiment of the present disclosure, an aspect ratio between the diameter D of the first surface 10a and the height H of the core cell 10 may be in a range from about 5.4:12 to about 5.4:14. In various embodiments of the present disclosure, the diameter D of the first surface 10a may be the same as the diameter of the second surface 10b, and according to one embodiment of the present disclosure, both the aspect ratio between the diameter D of the first surface 10a and the height H of the core cell 10 and the aspect ratio of the diameter D of the second surface 10b and the height H of the core cell 10 may be in a range of about 5.4:12 to about 5.4:14. The battery, according to one embodiment of the present disclosure, may include the slimmed core cell 10 to reduce a battery installation space and contribute to slimming of a device to which a battery is to be mounted. For example, when the core cell 10 having a height H that exceeds the above-described range of aspect ratios, the set device may not be slimmed. Further, when the core cell 10 having a height H exceeding the above-described range of aspect ratios, a shape of an electrode assembly forming an internal structure of the core cell 10 may be excessively limited, and accordingly, an appropriate output of the core cell 10 or of a battery including the core cell 10 may not be provided.

In one embodiment of the present disclosure, the first and second surfaces 10a and 10b may respectively act as first and second electrodes having different polarities and may act as the first and second electrode surfaces 10a and 10b having different polarities. In the accompanying drawings, the first and second electrode surfaces 10a and 10b are respectively denoted by the same reference numerals as the first and second surfaces 10a and 10b and may respectively indicate substantially the same surfaces as the first and second surfaces 10a and 10b. Unless otherwise specified, the first and second surfaces 10a and 10b may respectively indicate the first and second electrode surface 10a and 10b, and as described below, technical configurations of the first and second surfaces 10a and 10b may be applied substantially the same as the first and second electrode surfaces 10a and 10b. However, in various embodiments of the present disclosure, only one of the first and second surfaces 10a and 10b may act as an electrode surface 10a or 10b, and the first and second electrode tabs 30 and 40 may be respectively connected to different portions on one surface acting as the electrode surface 10a or 10b.

Throughout the present specification, the first and second electrode surfaces 10a and 10b may expose polarities toward the outside and may indicate, for example, surfaces to which the first and second electrode tabs 30 and 40 are respectively connected to form a charging path and a discharging path of the core cell 10. In various embodiments of the present disclosure, only one of the first and second surfaces 10a and 10b opposite to each other may act as an electrode surface, and the other thereof may not act as an electrode surface. In some embodiments, one of the first and second surfaces 10a and 10b may act as an electrode surface on which both the first and second electrodes having different polarities are formed. In embodiments of the present disclosure, the first and second electrodes may be formed differently depending on positions of the first and second electrode surfaces 10a and 10b. For example, the first electrode may be formed at a central position of the first electrode surface 10a or the second electrode surface 10b and the second electrode having a different polarity from the first electrode may be formed at a border (e.g., a periphery) of the first electrode surface 10a or the second electrode surface 10b. In addition, an insulation gap may be formed between the first and second electrodes on the first electrode surface 10a or the second electrode surface 10b to provide insulation (e.g., the provide electrical insulation) between the first and second electrodes.

In one embodiment of the present disclosure, the first and second surfaces 10a and 10b may be respectively electrically connected to first and second electrode plates of an electrode assembly accommodated in the core cell 10 and may be electrically connected to a set device through the first and second electrode tabs 30 and 40 respectively conductively connected to the first and second surfaces 10a and 10b. For example, the set device may be (or may represent) an external load for receiving discharging power of the core cell 10 or an external charger for supplying charging power to the core cell 10. For example, the first and second electrode tabs 30 and 40 may provide a charging path or a discharging path forming a flow of discharging power or charging power of the core cell 10 and may be a part of the charging path or the discharging path.

In one embodiment of the present disclosure, the first and second electrode tabs 30 and 40 may be respectively conductively connected to the first and second surfaces 10a and 10b respectively through the first and second conductive compression layers 35 and 45. For example, the first and second conductive compression layers 35 and 45 may be respectively between the first electrode tab 30 and the first surface 10a and between the second electrode tab 40 and the second surface 10b to respectively provide a conductive connection between the first electrode tab 30 and the first surface 10a and a conductive connection between the second electrode tab 40 and the second surface 10b. In various embodiments of the present disclosure, conductive connections respectively using the first and second conductive compression layers 35 and 45 may be made at two different locations respectively between the first electrode tab 30 and the first surface 10a and between the second electrode tab 40 and the second surface 10b, that is, at two different locations in the third direction Z3. The present disclosure, however, is not limited thereto, and a conductive connection using the first conductive compression layer 35 or the second conductive compression layer 45 may be made in at least one of a location between the first electrode tab 30 and the first surface 10a and between the second electrode tab 40 and the second surface 10b. In various embodiments of the present disclosure, a conductive connection using the first or second conductive compression layers 35 or 45 may be selectively made at a location between the first and second electrode tabs 30 and 40 and the first and second surfaces 10a and 10b, and a conductive connection may be made at the other location by using a thermal bonding method that does not use conductive transition due to compression, such as laser welding.

In one embodiment of the present disclosure, an electrode assembly may be accommodated in the core cell 10, and the electrode assembly may include first and second electrode plates and may be formed in a winding shape in which a separator arranged between the first and second electrode plates is wound in a roll shape or may also be formed in a stacked structure in which the first and second electrode plates and the separator are stacked. The first and second electrode plates of the electrode assembly may be respectively connected to the first and second surfaces 10a and 10b of the core cell 10 and may be respectively connected to the first and second electrode tabs 30 and 40 respectively through the first and second surfaces 10a and 10b.

The first and second electrode tabs 30 and 40 may respectively include the rim portions 32 and 42 conductively connected to at least one of the first and second surfaces 10a and 10b and may respectively form (or have) accommodation spaces G1 and G2 respectively surrounded by the rim portions 32 and 42 and may respectively include protrusion portions 31 and 41 respectively protruding from the rim portions 32 and 42 in the first direction Z1. In one embodiment of the present disclosure, the first and second electrode tabs 30 and 40 may respectively include the first and second rim portions 32 and 42 respectively conductively connected to the first and second surfaces 10a and 10b respectively acting as the first and second electrode surfaces 10a and 10b and the first and second protrusion portions 31 and 41 respectively protruding from the first and second rim portions 32 and 42 to positions outside the first and second electrode surfaces 10a and 10b. In addition, the first and second accommodation spaces G1 and G2 respectively surrounded by the first and second rim portions 32 and 42 may be formed respectively on the first and second electrode surfaces 10a and 10b. Throughout the present disclosure, the first and second rim portions 32 and 42 may be collectively referred to as rim portions 32 and 42, and unless otherwise specified, technical details of the rim portions 32 and 42 may be commonly applied to the first and second rim portions 32 and 42. Similarly, the first and second accommodation spaces G1 and G2 may be collectively referred to as accommodation spaces G1 and G2, and unless otherwise specified, technical details of the accommodation spaces G1 and G2 may be commonly applied to the first and second accommodation spaces G1 and G2. In addition, the first and second protrusion portions 31 and 41 may be collectively referred to as protrusion portions 31 and 41, and unless otherwise specified, technical details of the protrusions portions 31 and 41 may be commonly applied to the first and second protrusion portions 31 and 41.

In one embodiment of the present disclosure, the first and second electrode tabs 30 and 40 may form a charging path and a discharging path, which include the protrusion portions 31 and 41 protruding from the rim portions 32 and 42 respectively conductively connected onto the first and second electrode surfaces 10a and 10b in the first direction Z1, respectively connecting the first and second electrode surfaces 10a and 10b to the outside. In one embodiment of the present disclosure, the rim portions 32 and 42 of the first and second electrode tabs 30 and 40 may be respectively conductively connected to the first and second electrode surfaces 10a and 10b and may be respectively physically coupled to the first and second electrode surfaces 10a and 10b. For example, the first and second electrode tabs 30 and 40 may be respectively physically coupled to the first and second electrode surfaces 10a and 10b of the core cell 10 respectively through the rim portions 32 and 42 and may be electrically connected thereto.

In one embodiment of the present disclosure, the first and second electrode tabs 30 and 40 extend to the outside of the first and second electrode surfaces 10a and 10b through the protrusion portions 31 and 41, and the first and second electrode tabs 30 and 40 (or the protrusion portions 31 and 41) protrude a length (e.g., a preset length) toward the outside of the first and second electrode surfaces 10a and 10b, that is, toward the outside of the core cell 10. However, the he first and second electrode tabs 30 and 40 (or the protrusion portions 31 and 41) may be vulnerable to physical interference from the external environment, and for example, an external moment tending to rotate the first and second electrode tabs 30 and 40 in a clockwise or counterclockwise direction may act on the electrode tabs 30 and 40 or the protrusion portions 31 and 41 protruding toward the outside of the core cell 10 about the center of the core cell 10 (or centrifuges of the first and second surfaces 10a and 10b) as the center of moment from external impact. Accordingly, in one embodiment of the present disclosure, the rim portions 32 and 42 of the first and second electrode tabs 30 and 40 respectively have sufficient coupling areas or conduction areas to the first and second electrode surfaces 10a and 10b and are arranged as far from the center of the core cell 10 as possible to have the greatest a resistance moment (e.g., the greatest length of a moment arm) with respect to the external moment. For example, in designing the rim portions 32 and 42 of the first and second electrode tabs 30 and 40, the rim portions 32 and 42 may be formed to respectively have hollow rim shapes surrounding peripheries of the first and second electrode tabs 30 and 40 to be spaced as far from the center of the core cell 10 as possible. In one embodiment of the present disclosure, the rim portions 32 and 42 may surround the first and second accommodation spaces G1 and G2 respectively formed on the first and second electrode surfaces 10a and 10b and may respectively accommodate the insulating resins 55 of the first and second conductive compression layers 35 and 45 in (or through) the accommodation spaces G1 and G2. The first and second electrode tabs 30 and 40 may be formed to have the rim portions 32 and 42 arranged outside the accommodation spaces G1 and G2 along borders of the accommodation spaces G1 and G2 to surround the accommodation spaces G1 and G2. For example, the accommodation spaces G1 and G2 of the first and second electrode tabs 30 and 40 may respectively form inner regions of the first and second electrode tabs 30 and 40, and the rim portions 32 and 42 of the first and second electrode tabs 30 and 40 may respectively form outer regions or outer border regions of the first and second electrode tabs 30 and 40. In other words, the rim portions 32 and 42 of the first and second electrode tabs 30 and 40 may be respectively formed along border regions forming outer peripheries of the first and second electrode tabs 30 and 40, and in one embodiment of the present disclosure illustrated in, for example, FIGS. 1 to 3, the rim portions 32 and 42 may not be formed in the inner regions of the first and second electrode tabs 30 and 40 and may not extend across the accommodation spaces G1 and G2 formed in the inner regions of the first and second electrode tabs 30 and 40. In one embodiment of the present disclosure illustrated in FIGS. 1 to 3, the accommodation space G1 or G2 may form one single space, and the rim portion 32 or 42 may surround the single accommodation space G1 or G2 and may not extend across the single accommodation space G1 or G2 and may not divide one single accommodation space G1 or G2 into a plurality of accommodation spaces while extending across the single accommodation space G1 or G2. As described above, an area of the rim portion 32 or 42 forming a coupling area or a conduction area between the first electrode tab 30 and the first electrode surface 10a or between the second electrode tab 40 and the second electrode surface 10b may be at a position far away from the center of the core cell 10, and by concentrating an area of the rim portion 32 or 42 on the outer region of the first or second electrode tab 30 or 40 rather than arranging the area of the rim portion 32 or 42 in the inner region of the first or second electrode tab 30 or 40, an arm of a resistance moment extending from the center of the core cell 10 may be formed to effectively resist an external impact (e.g., an external moment). In one embodiment of the present disclosure, the rim portions 32 and 42 of the first and second electrode tabs 30 and 40 may be respectively conductively connected to the first and second electrode surfaces 10a and 10b to form charging and discharging paths of a battery and may resist an external impact while being respectively physically coupled to the first and second electrode surfaces 10a and 10b. Further, the accommodation spaces G1 and G2 of the first and second electrode tabs 30 and 40 may be formed as free spaces surrounded by the rim portions 32 and 42, and accordingly, the accommodation spaces G1 and G2 may not substantially contribute to resist charging and discharging of the battery or an external impact.

In one embodiment of the present disclosure, the first and second electrode tabs 30 and 40 may respectively include the first and second rim portions 32 and 42 respectively surrounding the first and second accommodation spaces G1 and G2 respectively formed on the first and second electrode surfaces 10a and 10b or the first and second surfaces 10a and 10b and the first and second protrusion portions 31 and 41 respectively extending from the first and second rim portions 32 and 42 in the first direction Z1. For example, in one embodiment of the present disclosure, the first and second electrode tabs 30 and 40 may respectively include the first and second rim portions 32 and 42 respectively surrounding the first and second accommodation spaces G1 and G2 on the first and second surfaces 10a and 10b, and the first and second electrode tabs 30 and 40 respectively include the first and second protrusion portions 31 and 41 respectively extending from the first and second rim portions 32 and 42 in the first direction Z1.

In one embodiment of the present disclosure, the first and second conductive compression layers 35 and 45 may be respectively between the first electrode tab 30 and the first surface 10a and between the second electrode tab 40 and the second surface 10b and may be respectively physically coupled and respectively electrically connected thereto. In one embodiment of the present disclosure, the first and second electrode tabs 30 and 40 may be formed in different shapes, and the first and second conductive compression layers 35 and 45 that are respectively physically coupled and respectively electrically connected between the first electrode tab 30 and the first surface 10a and between the second electrode tab 40 and the second surface 10b may be formed in substantially different shapes corresponding to the first and second electrode tabs 30 and 40.

The different shapes of the first and second electrode tabs 30 and 40 are described in more detail below. The first rim portion 32 of the first electrode tab 30 formed on the first electrode surface 10a may be relatively wide in the first direction Z1 in which the first protrusion portion 31 extends, and in one embodiment, a first width W1 of the first rim portion 32 in the first direction Z1 may be greater than a second width W2 of the first rim portion 32 in the second direction Z2 (see, e.g., FIG. 3A). In addition, the second rim portion 42 of the second electrode tab 40 formed on the second electrode surface 10b may be relatively wide in the second direction Z2 crossing the first direction Z1 in which the second protrusion portion 41 extends, and in one embodiment, a fourth width W4 of the second rim portion 42 in the second direction Z2 may be greater than a third width W3 of the second rim portion 42 in the first direction Z2 (see, e.g., FIG. 3B). In one embodiment of the present disclosure, the first and third widths W1 and W3 may indicate widths of the first and second rim portions 32 and 42 measured in the first direction Z1 and may also indicate, for example, the greatest width from among widths of the entire shapes of the first and second rim portions 32 and 42 measured in the first direction Z1. Similarly, in one embodiment of the present disclosure, the second and fourth widths W2 and W4 may indicate widths of the first and second rim portions 32 and 42 measured in the second direction Z2 and may also indicate, for example, the greatest width from among widths of the entire shapes of the first and second rim portions 32 and 42 measured in the second direction Z2. In one embodiment of the present disclosure, the first direction Z1 and the second direction Z2 may correspond to directions crossing each other, for example, directions that are perpendicular to each other.

In one embodiment of the present disclosure, by providing the first to fourth widths W1, W2, W3, and W4 of the first and second electrode tabs 30 and 40 respectively formed on the first and second surfaces 10a and 10b to have different directions in the first and second directions Z1 and Z2 may provide sufficient rigidity to the first and second electrode tabs 30 and 40 to protect against an external impact and may be made by considering electrical connections between the first and second electrode tabs 30 and 40 and the first and second electrode surfaces 10a and 10b. For reference, in one embodiment of the present disclosure, the first and second electrode tabs 30 and 40 having different directions in the first and second directions Z1 and Z2 may mean that the first electrode tab 30 has the greatest width in the first direction Z1 and the second electrode tab 40 has the greatest width in the second direction Z2. In various embodiments of the present disclosure, specific shapes of the first and second electrode tabs 30 and 40 may be variously modified, and despite the various modifications of the specific shapes of the first and second electrode tabs 30 and 40, the entire shapes of the first and second electrode tabs 30 and 40 may have directivity in (e.g., may primarily extend in) the first and second directions Z1 and Z2, and the directivities of the first and second electrode tabs 30 and 40 formed to be the widest in the first and second directions Z1 and Z2 may be maintained throughout the various embodiments.

In one embodiment of the present disclosure, the first electrode tab 30 may include the first protrusion portion 31 extending along the side surface 10c of the core cell 10 in the third direction Z3 crossing the first and second directions Z1 and Z2 from the rim portion 32 formed on the first electrode surface 10a in the first and second directions Z1 and Z2. For example, in one embodiment of the present disclosure, the first protrusion portion 31 may extend from the first rim portion 32 formed on the first electrode surface 10a downwardly toward the second protrusion portion 41 along the side surface 10c, which connects between the first and second electrode surfaces 10a and 10b.

Different from the first electrode tab 30, the second electrode tab 40 may extend in a direction parallel to the second electrode surface 10b from the second rim portion 42 formed on the second electrode surface 10b in the first and second directions Z1 and Z2 and may extend at the same level in the third direction Z3 crossing the first and second directions Z1 and Z2.

In one embodiment of the present disclosure, the first and second protrusion portions 31 and 41 respectively extend from the first and second rim portions 32 and 42 of the first and second surfaces 10a and 10b formed at different levels in the third direction Z3, and the first protrusion portion 31 extends downwardly along the side surface 10c of the core cell 10 from the first rim portion 32 on the first electrode surface 10a toward the second protrusion portion 41 extending from the second electrode surface 10b. Accordingly, input/output terminals 31a and 41a of the first and second protrusion portions 31 and 41 may approach adjacent levels (e.g., may be near to each other) in the third direction Z3 such that connections to external devices may be easily made through the input/output terminals 31a and 41a of the first and second protrusion portions 31 and 41 and charging and discharging paths of the core cell 10 may be reduced. In one embodiment of the present disclosure, while applying the core cell 10 having a slimmed shape in which an aspect ratio between a plane formed in the first and second directions Z1 and Z2 (e.g., a diameter D of the first surface 10a or a diameter of the second surface 10b) and the height H of the core cell 10 in the third direction Z3 is relatively large, the input/output terminals 31a and 41a of the first and second protrusion portions 31 and 41 may be formed to be near to each other along the height H of the core cell 10, and the first protrusion portion 31 may extend toward the second protrusion portion 41 in the third direction Z3 to reduce a level difference between the first and second protrusion portions 31 and 41 in the third direction Z3. Thus, a distance between the input/output terminals 31a and 41a of the first and second protrusion portions 31 and 41, that is, a distance between the input/output terminals 31a and 41a in the third direction Z3 may be reduced. As described above, in one embodiment of the present disclosure, a distance between the input/output terminals 31a and 41a formed by extended ends of the first and second protrusion portions 31 and 41 is reduced, and thus, convenience of connection to an external device may be improved and charging and discharging paths of the core cell 10 via the input/output terminals 31a and 41a of the first and second protrusion portions 31 and 41 may be reduced.

The second protrusion portion 41 may be at a level corresponding to the bottom of the core cell 10 in the third direction Z3 (e.g., at a level of the second electrode surface 10b forming the bottom of the core cell 10). The second protrusion portion 41 at this low level may, however, be vulnerable to an external environment, for example, an external impact. Accordingly, the second rim portion 42 from which the second protrusion portion 41 extends may extend to have directivity in (e.g., may primarily extend in) the second direction Z2 to more effectively resist an external impact transferred through the second protrusion portion 41.

For example, the fourth width W4 of the second rim portion 42 in the second direction Z2 is greater than the third width W3 of the second rim portion 42 in the first direction Z1, and accordingly, the second rim portion 42 may effectively resist an external impact in the second direction Z2 transferred through the second protrusion portion 41 that is formed at the same level as the bottom of the core cell 10 and is relatively vulnerable to the external impact. That is, an external impact transferred through the second protrusion portion 41 is not applied to the second rim portion 42 in the first direction Z1 in which the second protrusion portion 41 extends but is instead transferred in the second direction Z2 different from the first direction Z1, and accordingly, the second electrode tab 40 including the second protrusion portion 41 may be twisted with respect to the core cell 10. To effectively protect the second electrode tab 40, the second rim portion 42 of the second electrode tab 40 is formed to be wider in the second direction Z2, and accordingly, the second electrode tab 40 may effectively resist the external impact.

The second rim portion 42 of the second electrode tab 40 may be coupled to a border region of the second surface 10b on which the second electrode is formed as a whole, and the second rim portion 42 may be formed to be wider in the second direction Z2 at or near a border region rather than at the center of the second surface 10b to more effectively resist an external impact acting through the second protrusion portion 41 extending from the second rim portion 42. In one embodiment of the present disclosure, the second rim portion 42 may include a front strip 42a having an arc shape following a circular border of the second electrode surface 10b such that an external impact through the second protrusion portion 41 is widely distributed in the second direction Z2 or generally along the circular border of the second electrode surface 10b in the second direction Z2, a rear strip 42b facing the front strip 42a and extending in one direction along the second direction Z2, and a pair of side strips 42c connecting (e.g., extending between) both ends of the front strip 42a to both ends of the rear strip 42b. In one embodiment of the present disclosure, the side strips 42c may extend from both ends of (e.g., may respectively extend from opposite ends of) the rear strip 42b at an obtuse angle (e.g., an angle greater than 90 degrees) with respect to the rear strip 42b to respectively connect both ends of the front strip 42a extending relatively widely in the second direction Z2 to the rear strip 42b extending relatively narrowly in the second direction Z2.

Different from the second rim portion 42 of the second electrode tab 40, the first rim portion 32 of the first electrode tab 30 may have the first width W1 relatively longer in the first direction Z1 from among the first and second directions Z1 and Z2 and that is greater than the second width W2 in the second direction Z2. The first electrode tab 30 may have a structure in which physical coupling and an electrical connection between the first rim portion 32 and the first electrode surface 10a are sufficiently formed at a position separated by an insulation distance formed by an insulating cap 20 on the first surface 10a. In one embodiment of the present disclosure, for example, the insulating cap 20 may be covered on the first electrode surface 10a, and the insulating cap 20 covered on the first electrode surface 10a may cover the first electrode surface 10a to prevent a second electrode other than the first electrode provided by the first electrode surface 10a from being exposed on the first electrode surface 10a. Here, the first and second electrodes may indicate different polarities provided by the first and second surfaces 10a and 10b or the first and second electrode surfaces 10a and 10b. For example, the first electrode surface 10a may act as a first electrode, the second electrode surface 10b may act as a second electrode different from the first electrode, the first electrode may be formed over most of the region including the center of the first electrode surface 10a, and different from the first electrode, the second electrode may be formed from the entire second electrode surface 10b of the core cell 10 to a border region of the first electrode surface 10a along the side surface 10c. In addition, by covering an upper portion of the first electrode surface 10a with the insulating cap 20 to cover the second electrode formed on the border region of the first electrode surface 10a, the second electrode is not exposed on the first electrode surface 10a. Further, the first rim portion 32 formed on the first electrode surface 10a is connected to both the first and second electrodes formed on the first electrode surface 10a, and the first and second electrodes having opposite polarities may be prevented from being short-circuited to each other. In this case, the insulating cap 20 may expose the first electrode on the first electrode surface 10a through a through-hole (e.g., an opening) 20′ in (e.g., aligned with or corresponding to) the center of the core cell 10 and may selectively cover the second electrode formed in the border region on the first electrode surface 10a. In addition, the first rim portion 32 coupled to the first electrode surface 10a may be formed widely in the first direction Z1 such that sufficient electrical connection and physical coupling between the first electrode tab 30 and the first electrode surface 10a may be made at a position separated by an insulation distance formed by the insulating cap 20. That is, the first rim portion 32 of the first electrode tab 30 may have the first width W1 in the first direction Z1 that is greater than the second width W2 in the second direction Z2, and accordingly, sufficient electrical connection and physical coupling to the first electrode formed in the first electrode surface 10a may be formed. In one embodiment of the present disclosure, the first rim portion 32 may have a long-side portion 32a extending in the first direction Z1 and a short-side portion 32b extending in the second direction Z2 crossing the first direction Z1. The first rim portion 32 may be formed in a substantially rectangular border shape by including a pair of long-side portions 32a and a pair of short-side portions 32b that respectively extend in the first and second directions Z1 and Z2.

Hereinafter, the first and second conductive compression layers 35 and 45, which are respectively between the first electrode tab 30 and the first surface 10a and between the second electrode tab 40 and the second surface 10b to make electrical connections and physical coupling therebetween, are described. Technical details of the conductive compression layers 35 and 45, to be described below, may be commonly applied to the first and second conductive compression layers 35 and 45, and hereinafter, the first conductive compression layer 35 from among the first and second conductive compression layers 35 and 45 is primarily described. The technical details of the first conductive compression layer 35 may be commonly applied to the second conductive compression layer 45.

Referring to FIG. 4, the first and second conductive compression layers 35 and 45 may each include conductive particles 51 for making electrical connections between the rim portions 32 and 42 of the first and second electrode tabs 30 and 40 and the first and second electrode surfaces 10a and 10b and an insulating resin 55 accommodated in the accommodation space G1 or G2 surrounded by (e.g., surrounded along its periphery by) the rim portion 32 or 42. The first and second conductive compression layers 35 and 45 may each include the conductive particles 51 and the insulating resin 55 that accommodates the conductive particles 51 and provides fluidity to the conductive particles 51. In one embodiment of the present disclosure, the first and second conductive compression layers 35 and 45 may make electrical connections between the first and second electrode tabs 30 and 40 and the first and second electrode surfaces 10a and 10b through transition from a non-conductive state (e.g., an insulation state) before a thermal compression to a conductive state after the thermal compression, that is, after transition of conductivity of the conductive compression layers 35 and 45. In other words, the conductive compression layers 35 and 45 may not be conductive before a thermal compression but may be conductive through (or after) the thermal compression. The thermal compression may use heat and pressure (e.g., preset heat and pressure) applied by using a pressure tool TO, and the conductive transition of the conductive compression layers 35 and 45 may be made by pressurizing between the first and second electrode tabs 30 and 40 and the first and second electrode surfaces 10a and 10b in directions facing each other with the conductive compression layers 35 and 45 interposed therebetween. In one embodiment of the present disclosure, the insulating resin 55, before a thermal compression, may include the conductive particles 51 substantially in a non-flowable state (e.g., a solid state or a gel state similar to the solid state), and after the thermal compression, the insulating resin 55 may be in a liquid state to provide fluidity to the conductive particles 51.

High pressure for the thermal compression may be applied between the rim portions 32 and 42 of the first and second electrode tabs 30 and 40 and the first and second electrode surfaces 10a and 10b, and accordingly, the insulating resin 55 with relatively high fluidity rather than the conductive particles 51 with relatively low fluidity may be pushed out between the rim portions 32 and 42 and the first and second electrode surfaces 10a and 10b to be accommodated in the accommodation spaces G1 and G2 surrounded by the rim portions 32 and 42. In addition, the conductive particles 51, which have lost (or reduced) fluidity due to the emission of the insulating resin 55 that provides fluidity, remain between the rim portions 32 and 42 of the first and second electrode tabs 30 and 40 and the first and second electrode surfaces 10a and 10b to provide electrical connections between the first and second electrode tabs 30 and 40 and the first and second electrode surfaces 10a and 10b. In one embodiment of the present disclosure, the accommodation spaces G1 and G2 for accommodating the insulating resins 55 of the first and second conductive compression layers 35 and 45 are provided, and accordingly, emission of the insulating resins 55 from spaces between the first and second electrode tabs 30 and 40 and the first and second electrode surfaces 10a and 10b may be allowed. The conductive particles 51, which have lost fluidity due to the emission of the insulating resin 55 that provides fluidity to the conductive particles 51, may be firmly fixed between the rim portions 32 and 42 of the first and second electrode tabs 30 and 40 and the first and second electrode surfaces 10a and 10b.

The battery, according to an embodiment of the present disclosure, may include the first rim portion 32 formed to surround the first accommodation space G1 while extending along a border of the first electrode tab 30 formed on the first electrode surface 10a and the second rim portion 42 formed to surround the second accommodation space G2 while extending along a border of the second electrode tab 40 formed on the second electrode surface 10b. The conductive particles 51, which have lost fluidity due to the emission of the insulating resins 55 pushed into the accommodation spaces G1 and G2 surrounded by the first and second rim portions 32 and 42, are fixed to positions between the first and second rim portions 32 and 42 and the first and second electrode surfaces 10a and 10b to make conductive connections therebetween.

In one embodiment of the present disclosure, the first and second rim portions 32 and 42 may respectively surround the first and second accommodation spaces G1 and G2 respectively on the first and second electrode surfaces 10a and 10b and may include, at positions adjacent to the first and second rim portions 32 and 42, the accommodation spaces G1 and G2 that may respectively accommodate the insulating resins 55 emitted by compression between the first and second rim portions 32 and 42 and the first and second electrode surfaces 10a and 10b. Accordingly, the emission of the insulating resins 55 may be promoted (or increased), and the first and second accommodation spaces G1 and G2 for respectively accommodating the insulating resins 55 pushed out of the first and second rim portions 32 and 42 may be formed to be surrounded by the first and second rim portions 32 and 42 so as not to disturb fixation of the conductive particles 51 due to unnecessary fluidity provided to the conductive particles 51 by excessive insulating resins 55 between the first and second rim portions 32 and 42 and the first and second electrode surfaces 10a and 10b or so as not to disturb conductive contacts between the first and second rim portions 32 and 42 and the first and second electrode surfaces 10a and 10b including the conductive particles 51 therebetween.

The conductive particles 51 of the conductive compression layers 35 and 45 formed between the rim portions 32 and 42 and the electrode surfaces 10a and 10b may be fixed between the rim portions 32 and 42 and the electrode surfaces 10a and 10b due to emission of the insulating resin 55 pushed into the accommodation space G1 and G2 by compression between the rim portion 32 and 42 and the electrode surfaces 10a and 10b, and accordingly, a conductive connection may be made between the electrode tabs 30 and 40 including the rim portions 32 and 42 and the electrode surfaces 10a and 10b.

Similarly, the conductive particles 51 of the second conductive compression layer 45 formed between the second rim portion 42 and the second electrode surface 10b may be fixed between the second rim portion 42 and the second electrode surface 10b due to emission of the insulating resin 55 pushed into the second accommodation space G2 by compression between the second rim portion 42 and the second electrode surface 10b, and accordingly, a conductive connection may be made between the second electrode tab 40 including the second rim portion 42 and the second electrode surface 10b.

In one embodiment of the present disclosure, the first and second rim portions 32 and 42 may be formed along borders of the first and second electrode tabs 30 and 40 and may form the first and second accommodation spaces G1 and G2, which are respectively surrounded by the first and second rim portions 32 and 42 and respectively accommodate the insulating resins 55 respectively on the first and second electrode surfaces 10a and 10b while being formed along borders of the first and second electrode tabs 30 and 40. In addition, the first and second conductive compression layers 35 and 45 may have sheet shapes with outlines following (or corresponding to) the first and second rim portions 32 and 42 to be respectively interposed between the first and second rim portions 32 and 42 and the first and second electrode surfaces 10a and 10b, which respectively make substantially conductive connections and may be formed, for example, in sheet shapes that respectively have outlines following borders of the first and second rim portions 32 and 42 and respectively cover the first and second accommodation spaces G1 and G2 respectively surrounded by the first and second rim portions 32 and 42.

In one embodiment of the present disclosure, the first and second rim portions 32 and 42 of the first and second electrode tabs 30 and 40 respectively formed on the first and second electrode surfaces 10a and 10b may have directivity along the first and second directions Z1 and Z2 and may be formed relatively wide along the first and second directions Z1 and Z2. Accordingly, the first and second conductive compression layers 35 and 45 respectively providing electrical connections to the first and second rim portions 32 and 42 may also have directivity along the first and second directions Z1 and Z2 and may be formed relatively wide along the first and second directions Z1 and Z2.

In one embodiment of the present disclosure, the first rim portion 32 may have a hollow rectangular border shape having the long-side portions 32a in the first direction Z1 and the short-side portions 32b in the second direction Z2, and the first conductive compression layer 35 conductively connected to the first rim portion 32 may have a rectangular sheet shape corresponding to the first rim portion 32.

In one embodiment of the present disclosure, the second rim portion 42 may include the front strip 42a having an arc shape and which is formed relatively wide in the second direction Z2 and follows a circular border of the second electrode surface 10b, the rear strip 42b extending in one direction along the second direction Z2, and the pair of side strips 42c respectively connecting both ends of the front strip 42a to both ends of the rear strip 42b. The second accommodation space G2 for accommodating the insulating resin 55 may be formed between the front strip 42a, the rear strip 42b, and the pair of side strips 42c. The second conductive compression layer 45 electrically connected to the second rim portion 42 may have a shape corresponding to a shape of the second rim portion 42, and in one embodiment of the present disclosure, the second conductive compression layer 45 may have a round shape following the front strip 42a of the second rim portion 42 or may have a plurality of bends to follow the front strip 42a of the second rim portion 42 in consideration of convenience in processing.

In one embodiment of the present disclosure, the first and second conductive compression layers 35 and 45 may each be formed in a sheet shape having an outline following the first or second rim portion 32 or 42, and for example, the first and second conductive compression layers 35 and 45 may each include an outer border following the first or second rim portion 32 or 42 and an inner side corresponding to the first or second accommodation space G1 or G2 surrounded by the first or second rim portion 32 or 42.

In one embodiment of the present disclosure, before and after the first and second electrode tabs 30 and 40 and the first and second electrode surfaces 10a and 10b are compressed, relative ratios of components (e.g., the conductive particles 51 and the insulating resins 55) of the first and second conductive compression layers 35 and 45 may change at outer borders and inner sides of the first and second conductive compression layers 35 and 45. For example, the relative ratios of the components (e.g., the conductive particles 51 and the insulating resins 55) of the first and second conductive compression layers 35 and 45 may be approximately the same as each other at the outer edges and the inner sides of the first and second conductive compression layers 35 and 45 before the first and second electrode tabs 30 and 40 and the first and second electrode surfaces 10a and 10b are compressed, but the relative ratios of the components (e.g., the conductive particles 51 and the insulating resins 55) of the first and second conductive compression layers 35 and 45 may change at the outer edges and the inner sides of the first and second conductive compression layers 35 and 45 after the first and second electrode tabs 30 and 40 and the first and second electrode surfaces 10a and 10b are compressed

For example, relative ratios of the insulating resins 55 may be reduced at the outer borders of the first and second conductive compression layers 35 and 45 after compression compared to the relative ratios before the compression because the insulating resins 55 are emitted due to the compression of the first and second electrode surfaces 10a and 10b and the rim portions 32 and 42 corresponding to the outer borders of the first and second conductive compression layers 35 and 45. In contrast, the relative ratios of the insulating resins 55 may increase at the inner sides of the first and second conductive compression layers 35 and 45 after the compression compared to the relative ratios before the compression because the insulating resins 55 are emitted into (e.g., are moved or pushed into) the accommodation spaces G1 and G2 corresponding to the inner sides of the first and second conductive compression layers 35 and 45. In other words, because the insulating resins 55 are pushed out of portions between the first and second rim portions 32 and 42 and the first and second electrode surfaces 10a and 10b due to compression between the first and second rim portions 32 and 42 and the first and second electrode surfaces 10a and 10b, the insulating resins 55 may be emitted into the first and second accommodation spaces G1 and G2 and a relative ratio of the conductive particles 51 may increase at the outer borders of the first and second conductive compression layers 35 and 45 corresponding to the first and second rim portions 32 and 42 while the relative ratios of the insulating resins 55 may increase inside the first and second conductive compression layers 35 and 45 corresponding to the first and second accommodation spaces G1 and G2 respectively surrounded by the first and second rim portions 32 and 42.

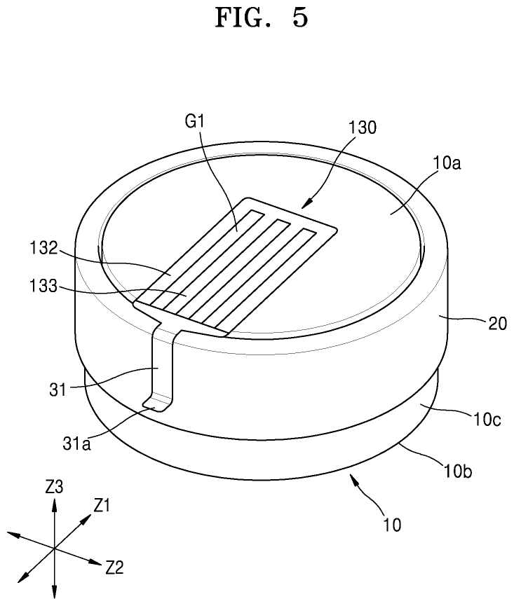

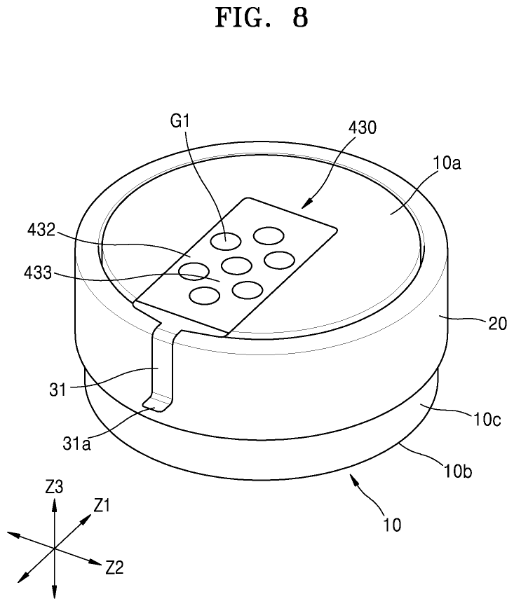

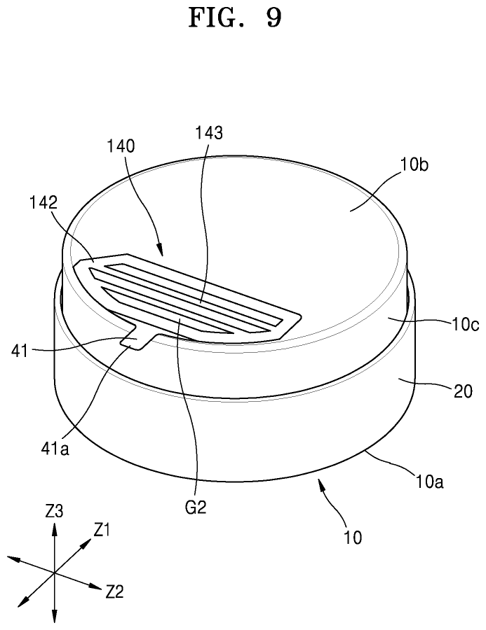

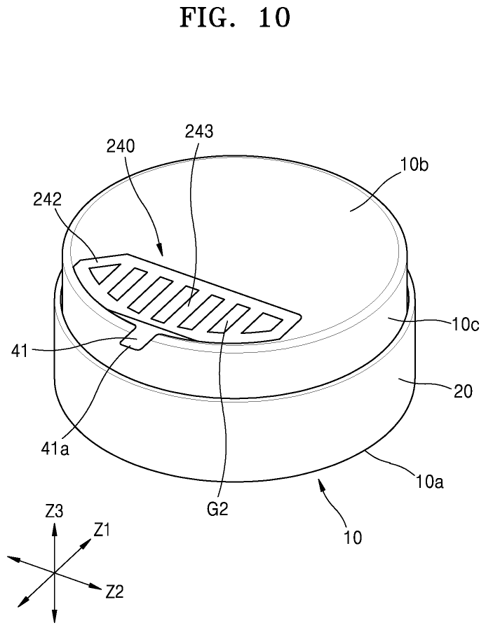

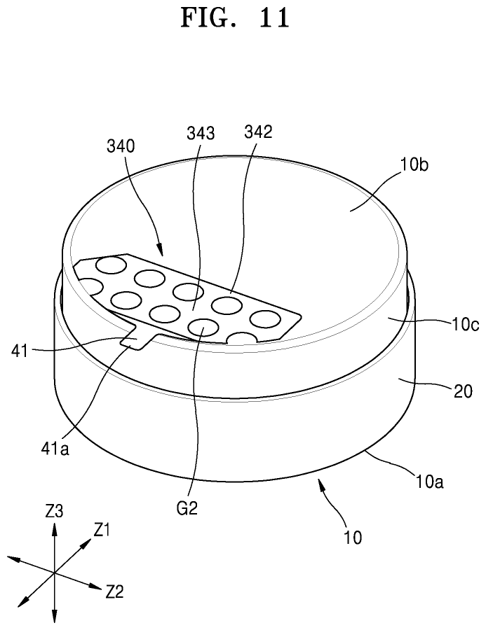

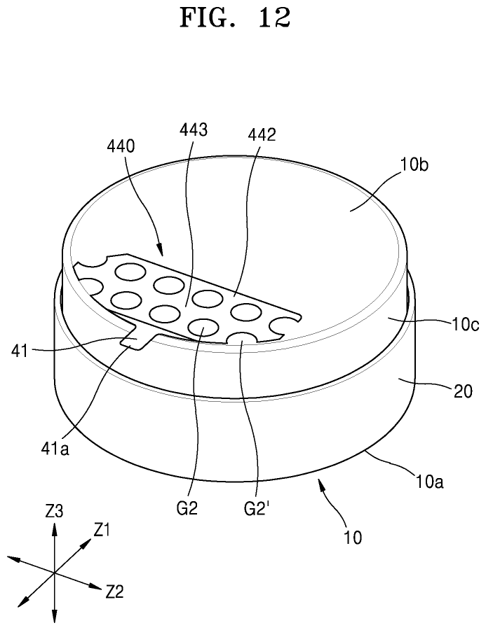

FIGS. 5 to 12 are views illustrating various shapes of electrode tabs 130, 230, 330, 430, 140, 240, 340, and 440 according to various embodiments of the present disclosure and illustrate modified embodiments of the first and second electrode tabs 30 and 40 illustrated in FIGS. 1 to 3. More specifically, FIGS. 5 to 8 are perspective views illustrating various embodiments of the first electrode tab 30 illustrated in FIG. 3A, and FIGS. 9 to 12 are perspective views illustrating various embodiments of the second electrode tab 40 illustrated in FIG. 3B.

As described above, in the embodiment illustrated in FIGS. 1 to 3, the first and second electrode tabs 30 and 40 may have rim shapes respectively surrounding a single first accommodation space G1 and a single second accommodation space G2 to form the single first accommodation space G1 and the single second accommodation space G2 respectively on the first and second electrode surfaces 10a and 10b. That is, the first and second rim portions 32 and 42 of the first and second electrode tabs 30 and 40 respectively formed on the first and second electrode surfaces 10a and 10b may extend along borders of the first and second electrode tabs 30 and 40 and may not extend across the inner sides of the first and second electrode tabs 30 and 40 and may not divide the single first and second accommodation spaces G1 and G2 into different spaces while crossing the inner sides of the first and second electrode tabs 30 and 40.

Different from the embodiment illustrated in FIGS. 1 to 3, in the embodiments illustrated in FIGS. 5 to 12, first and second electrode tabs 130, 230, 330, 430, 140, 240, 340, and 440 formed on the first and second electrode surfaces 10a and 10b may include first and second rim portions 132, 232, 332, 432, 142, 242, 342, and 442 extending along borders of the first and second electrode tabs 130, 230, 330, 430, 140, 240, 340, and 440 and first and second pattern portions 133, 233, 333, 433, 143, 243, 343, and 443 formed inside the first and second rim portions 132, 232, 332, 432, 142, 242, 342, and 442. The first and second pattern portions 133, 233, 333, 433, 143, 243, 343, and 443 may form a plurality of first and second accommodation spaces G1, G2, or G2′ at least partially surrounded by the first and second rim portions 132, 232, 332, 432, 142, 242, 342, and 442. In the embodiments illustrated in FIGS. 5 to 12, the first and second pattern portions 133, 233, 333, 433, 143, 243, 343, and 443 may include a plurality of strips extending in the first direction Z1 and may form, for example, the plurality of first and second accommodation spaces G1, G2, and G2′ extending in the first direction Z1 by including the plurality of strips extending in the first direction Z1 or may form, for example, the plurality of first and second accommodation spaces G1, G2, and G2′ extending in the second direction Z2 by including the plurality of strips extending in the second direction Z2.

As described above, the first and second pattern portions 133, 233, 333, 433, 143, 243, 343, and 443 may include a plurality of strips extending in one direction along the first direction Z1 or the second direction Z2 to form the plurality of first and second accommodation spaces G1, G2, and G2′ extending in the first direction Z1 or the second direction Z2. In these embodiments, the first direction Z1 may refer to an extension direction of the first and second protrusion portions 31 and 41 of the first and second electrode tabs 130, 230, 330, 430, 140, 240, 340, and 440 including the first and second pattern portions 133, 233, 333, 433, 143, 243, 343, and 443, and the second direction Z2 may correspond to a direction perpendicular to the first direction Z1.

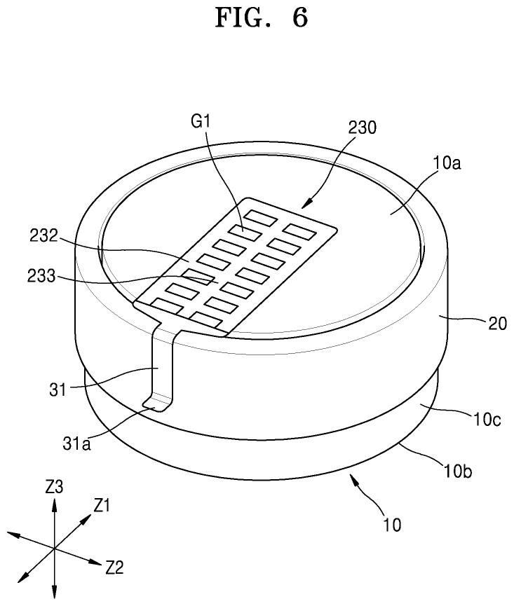

In the embodiment illustrated in FIG. 6, the first pattern portion 232 may include strips extending in the first and second directions Z1 and Z2 to form a plurality of first accommodation spaces G1 partitioned in the first and second directions Z1 and Z2. For example, in the embodiment illustrated in FIG. 6, the plurality of first accommodation spaces G1 may be arranged in a matrix of columns and rows in the first and second directions Z1 and Z2. A second pattern portion formed on the second electrode surface 10b may similarly include a plurality of strips extending in the first and second directions Z1 and Z2 to form the plurality of second accommodation spaces G2 arranged in a matrix of columns and rows in the first and second directions Z1 and Z2 similar to the first pattern portion 232 formed on the first electrode surface 10a.

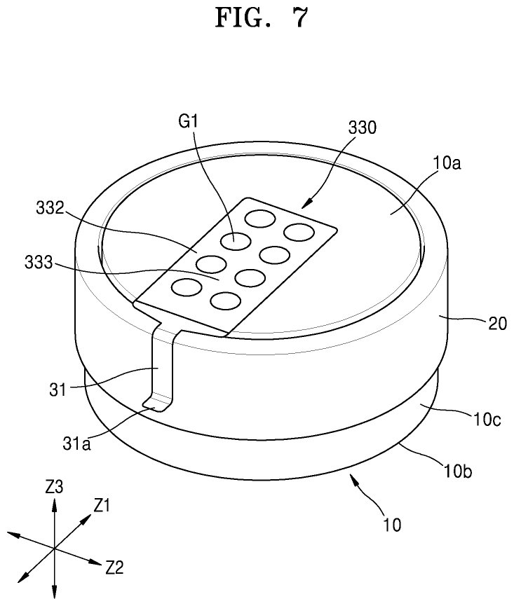

In the embodiments illustrated in FIGS. 7, 8, 11, and 12, each of the first and second accommodation spaces G1, G2, and G2′ may have a uniform unit shape, for example, a unit shape such as a rectangle or a circle. The first and second accommodation spaces G1 and G2 having the unit shape may be repeatedly formed along the first and second electrode tabs 30 and 40 and may be alternately arranged together with strips forming the first and second pattern portions 333, 433, 343, and 443.

In an embodiment in which a single first accommodation space G1 and a single second accommodation space G2 are formed by respectively using the first and second rim portions 32 and 42 respectively formed along borders of the first and second electrode tabs 30 and 40, such as is shown in FIGS. 1 to 3, coupling areas coupled to the first and second electrode surfaces 10a and 10b or conduction areas (corresponding to areas of the first and second rim portions 32 and 42) may be placed at locations apart (e.g., spaced apart from) from the center of the first and second electrode surfaces 10a and 10b, and thus, an arm of resistance moment capable of effectively counteracting an external impact is provided. In a structure in which areas of the first and second rim portions 32 and 42 corresponding to coupling areas or conduction areas to the first and second electrode surfaces 10a and 10b are placed far from the center of the first and second electrode surfaces 10a and 10b to form a long arm of resistance moment that may effectively resist an external impact, such as is shown in FIGS. 1 to 3, the coupling areas or the conduction areas of the first and second electrode tabs 30 and 40 may be distributed over a relatively wide area through the relatively widely distributed areas of the first and second rim portions 32 and 42 compared to the same area, charging and discharging paths provided by the first and second electrode tabs 30 and 40 may be that much longer, and thus, electrical resistances of the first and second electrode tabs 30 and 40 may increase compared to the same area.

Different from the embodiment illustrated in FIGS. 1 to 3, in the embodiments illustrated in FIGS. 5 to 12, in order to reduce an electrical resistance between the first and second electrode surfaces 10a and 10b, the first and second rim portions 132, 232, 332, 432, 142, 242, 342, and 442 extending along borders of the first and second electrode tabs 130, 230, 330, 430, 140, 240, 340, and 440 and the first and second pattern portions 133, 233, 333, 433, 143, 243, 343, and 443 partitioning the plurality of first and second accommodation spaces G1, G2, and G2′ in the inner sides of the first and second rim portions 132, 232, 332, 432, 142, 242, 342, and 442 may be formed, and the coupling areas or the conduction areas of the first and second electrode tabs 130, 230, 330, 430, 140, 240, 340, and 440 may be intensively arranged in relatively small areas through the first and second pattern portions 133, 233, 333, 433, 143, 243, 343, and 443 formed in the first and second rim portions 132, 232, 332, 432, 142, 242, 342, and 442. Thus, electrical resistances of the first and second electrode tabs 130, 230, 330, 430, 140, 240, 340, and 440 may be reduced. For example, the plurality of first and second accommodation spaces G1, G2, and G2′ may be surrounded by first and second rim portions 132, 232, 332, 432, 142, 242, 342, and 442 or the first and second pattern portions 133, 233, 333, 433, 143, 243, 343, and 443, and the insulating resins 55 pushed out of regions between the first and second rim portions 132, 232, 332, 432, 142, 242, 342, and 442 or the first and second pattern portions 133, 233, 333, 433, 143, 243, 343, and 443 and the first and second electrode surfaces 10a and 10b due to compression of the first and second electrode tabs 130, 230, 330, 430, 140, 240, 340, and 440 may be accommodated in the first and second accommodation spaces G1, G2, and G2′ adjacent thereto. That is, the insulating resins 55 may be accommodated in the first and second accommodation spaces G1, G2, and G2′ surrounded by the first and second rim portions 132, 232, 332, 432, 142, 242, 342, and 442 or the first and second pattern portions 133, 233, 333, 433, 143, 243, 343, and 443 to promote emission of the insulating resins 55. The conductive particles 51, which lose fluidity according to the emission of the insulating resins 55, may be fixed between the first and second rim portions 132, 232, 332, 432, 142, 242, 342, and 442 or the first and second pattern portions 133, 233, 333, 433, 143, 243, 343, and 443 and the first and second electrode surfaces 10a and 10b, and thus, an electrical connection can be reliably made therebetween.

The first and second pattern portions 133, 233, 333, 433, 143, 243, 343, and 443 illustrated in FIGS. 5 to 12 may form the first and second accommodation spaces G1, G2, and G2′, each being divided into a plurality of spaces, while following either one of the first and second directions Z1 and Z2 or both the first and second directions Z1 and Z2, that is, by using any one of the first and second directions Z1 and Z2 as a primary direction and including branches from the main direction to the other directions. For example, in one embodiment of the present disclosure, the first and second pattern portions 333, 433, 343, and 443 may partition the plurality of first and second accommodation spaces G1, G2, and G2′, each being formed in a unit shape, by using any one of the first and second directions Z1 and Z2 as a primary direction, by including branches from the main direction to other directions, and by including the first and second pattern parts 333, 433, 343, and 443 branching from the main direction. In such an embodiment, the first and second accommodation spaces G1, G2, and G2′ may be formed at the same position in the first direction Z1 or the second direction Z2 by including the first and second pattern portions 333, 433, 343, and 443 branching from the main direction at the same position in the first direction Z1 or the second direction Z2. In other embodiments, the first and second accommodation spaces G1, G2, and G2′ may be formed at positions staggered from each other in the first direction Z1 or the second direction Z2 by including the first and second pattern portions 333, 433, 343, and 443 branching from the main direction at a staggered position in the first direction Z1 or the second direction Z2. For example, in one embodiment of the present disclosure, the first and second accommodation spaces G1, G2, and G2′ may be arranged in a row in the first direction Z1 or the second direction Z2 corresponding to the main direction of the first and second pattern portions 333 and 343, and the first and second accommodation spaces G1, G2, and G2′ in adjacent rows in the second direction Z2 or the first direction Z1 different from the main direction may be formed at the same position in the second direction Z2 or the first direction Z1 different from the main direction. In another embodiment of the present disclosure, the first and second accommodation spaces G1 and G2 may be arranged in a row in the first direction Z1 or the second direction Z2 corresponding to the main direction of the first and second pattern portions 433 and 443 and may be formed at positions staggered from each other in the second direction Z2 or the first direction Z1 different from the main direction.

In the embodiments illustrated in FIGS. 5 to 12, the first and second accommodation spaces G1, G2, and G2′, each being divided into a plurality of spaces, may be formed as spaces closed from the outside of the first and second electrode tabs 130, 230, 330, 430, 140, 240, 340, and 440 or may be formed as open spaces toward the outside of the first and second electrode tabs 130, 230, 330, 430, 140, 240, 340, and 440. For example, in various embodiments of the present disclosure, the first and second accommodation spaces G1 and G2 may be formed in a shape elongated in the first direction Z1 or the second direction Z2, and the first and second accommodation spaces G1 and G2 extending long in (e.g., primarily extending in) any one of the first and second directions Z1 and Z2 may be formed in a closed shape from the outside of the first and second electrode tabs 130, 230, 330, 430, 140, 240, 340, and 440. Further, some of the plurality of first and second accommodation spaces G1, G2, and G2′ that include branches in the first and second directions Z1 and Z2 and are arranged in the first direction Z1 corresponding to the main direction and the second direction Z2 different from the main direction, for example, the first and second accommodation spaces G1 and G2, may be formed in a closed shape from the outside of the first and second electrode tabs 30 and 40, and the other of the first and second accommodation spaces G1, G2, and G2′, for example, the second accommodation space G2′, may be formed in an open shape toward the outside of the first and second electrode tabs 130, 230, 330, 430, 140, 240, 340, and 440, for example, the second electrode tabs 340 and 440. The first and second accommodation spaces G1 and G2 may provide sufficient spaces to accommodate the insulating resins 55 of the conductive compression layers 35 and 45. For example, the first and second accommodation spaces G1 and G2 having an open shape toward the outside of the first and second electrode tabs 130, 230, 330, 430, 140, 240, 340, and 440, for example, the second accommodation space G2′, may accommodate a greater volume of the insulating resins 55 of the conductive compression layers 35 and 45 compared to the first and second accommodation spaces G1 and G2 having a closed shape from the outside of the first and second electrode tabs 130, 230, 330, 430, 140, 240, 340, and 440. In one embodiment of the present disclosure, the first and second accommodation spaces G1 and G2 extending long in any one of the first and second directions Z1 and Z2 may accommodate a relatively large volume of the insulating resins 55, and the first and second accommodation spaces G1 and G2 having a shape closed from the outside of the first and second electrode tabs 130, 230, 330, 430, 140, 240, 340, and 440 may be formed by considering uncontrolled flows of the insulating resins 55 toward the outside of the first and second electrode tabs 130, 230, 330, 430, 140, 240, 340, and 440. Because the first and second accommodation spaces G1 and G2 arranged in the first and second directions Z1 and Z2 including branches of the first and second directions Z1 and Z2 may have limitations in accommodating a large volume of the insulating resins 55, the first and second accommodation spaces G1 and G2 (e.g., the second accommodation spaces G2′) formed at boundaries of the first and second electrode tabs 130, 230, 330, 430, 140, 240, 340, and 440 (e.g., the second electrode tabs 340 and 440) may be formed in an open shape toward the outside of the first and second electrode tabs 130, 230, 330, 430, 140, 240, 340, and 440 (e.g., the second electrode tabs 340 and 440). For example, the plurality of first and second accommodation spaces G1, G2, and G2′ arranged in the first and second directions Z1 and Z2 may each be repeatedly arranged in a uniform unit shape, and in such an embodiment, while unit shapes are repeatedly arranged according to the first and second electrode tabs 130, 230, 330, 430, 140, 240, 340, and 440, unit shapes formed at positions separated from boundaries of the first and second electrode tabs 130, 230, 330, 430, 140, 240, 340, and 440 may form the first and second accommodation spaces G1 and G2 having a closed shape from the outside of the first and second electrode tabs 130, 230, 330, 430, 140, 240, 340, and 440. Unit shapes in contact with the boundaries of the first and second electrode tabs 130, 230, 330, 430, 140, 240, 340, and 440 (e.g., the second electrode tabs 340 and 440) may form the first and second accommodation spaces G1 and G2 (e.g., the second accommodation space G2′) having an open shape toward the outside of the first and second electrode tabs 130, 230, 330, 430, 140, 240, 340, and 440 (e.g., the second electrode tab 340 and 440).

In one embodiment of the present disclosure, the first and second conductive compression layers 35 and 45 may each include an anisotropic conductive film (ACF), an anisotropic conductive paste (ACP), etc., and in one embodiment of the present disclosure, the first and second conductive compression layers 35 and 45 may each include an ACF including the insulating resin 55 that exists in a solid state below a glass transition temperature and undergoes a phase change to a liquid phase or a gel phase close to the liquid phase above the glass transition temperature.

Referring to FIGS. 1 to 3, in one embodiment of the present disclosure, the first and second electrode tabs 30 and 40 may include the first and second rim portions 32 and 42 respectively formed on the first and second electrode surfaces 10a and 10b and the first and second protrusion portions 31 and 41 extending from the first and second rim portions 32 and 42 to positions outside the first and second electrode surfaces 10a and 10b and may be integrally formed therewith. The first and second electrode tabs 30 and 40 may be made of a metal material, which has good electrical conductivity and excellent affinity with the first and second electrode surfaces 10a and 10b, for example, aluminum, copper, nickel, etc., by considering strength of electrical connection and physical coupling with each of the first and second electrode surfaces 10a and 10b.

According to embodiments of the present disclosure, a battery is provided having improved electrical connection reliability between a core cell and an electrode tab forming charging and discharging paths of the core cell and facilitates a connection process.

It should be understood that the embodiments described herein should be considered in a descriptive sense and not for purposes of limitation. Further, descriptions of features and aspects within each embodiment should typically be considered as available for other similar features and aspects in other embodiments. While various embodiments of the present disclosure have been described with reference to the figures, it will be understood by those of ordinary skill in the art that various changes in form and details may be made therein without departing from the spirit and scope of the present disclosure as defined by the following claims and their equivalents.

What is claimed is:

1. A battery comprising:
a core cell having a first surface and a second surface opposite to the first surface;
an electrode tab comprising a rim portion forming an accommodation space, the rim portion being conductively connected to an electrode surface formed by at least one of the first surface and the second surface of the core cell, the accommodation space being surrounded along its periphery by the rim portion on the electrode surface; and
a conductive compression layer between the electrode surface and the electrode tab to form a conductive connection, the conductive compression layer comprising an insulating resin and conductive particles suspended in the insulating resin, the insulating resin being accommodated in the accommodation space.

2. The battery of claim 1, wherein the electrode tab further comprises a protrusion portion extending in a first direction from the rim portion on the electrode surface to a position outside the electrode surface.

3. The battery of claim 2, wherein the rim portion has a first width in the first direction and a second width in a second direction crossing the first direction, and
wherein the first width is greater than the second width.

4. The battery of claim 1, wherein the electrode tab comprises a first electrode tab and a second electrode tab, the first electrode tab being conductively connected to a first electrode surface formed by the first surface, the second electrode tab being conductively connected to a second electrode surface formed by the second surface,
wherein the first electrode tab comprises a first protrusion portion extending in a first direction from the first electrode surface to a position outside the first electrode surface, and
wherein the second electrode tab comprises a second protrusion portion extending in the first direction from the second electrode surface to a position outside the second electrode surface.

5. The battery of claim 4, wherein the first protrusion portion extends from a first rim portion on the first electrode surface toward the second protrusion portion along a side surface of the core cell extending between the first surface to the second surface.

6. The battery of claim 4, wherein the second protrusion portion extends parallel to the second electrode surface from a second rim portion on the second electrode surface.

7. The battery of claim 4, wherein a first rim portion of the first electrode tab on the first electrode surface has a first width in the first direction and a second width in a second direction crossing the first direction, the first width being greater than the second width, and
wherein a second rim portion of the second electrode tab on the second electrode surface has a fourth width in the second direction and a third width in the first direction, the fourth width being greater than the third width.

8. The battery of claim 7, wherein the second direction is perpendicular to the first direction.

9. The battery of claim 4, wherein a first rim portion of the first electrode tab on the first electrode surface comprises a long-side portion extending in the first direction and a short-side portion extending in a second direction crossing the first direction to form a rectangular border shape.

10. The battery of claim 9, wherein the conductive compression layer comprises a first conductive compression layer conductively connecting the first electrode tab to the first electrode surface, and
wherein the first conductive compression layer has a rectangular sheet shape with a contour following the first rim portion and covers a first accommodation space surrounded along its periphery by the first rim portion.

11. The battery of claim 4, wherein a second rim portion of the second electrode tab on the second electrode surface comprises a front strip having an arc shape following a circular border of the second electrode surface, a rear strip extending in one direction along a second direction crossing the first direction, and side strips connecting both ends of the front strip to both ends of the rear strip.

12. The battery of claim 11, wherein the side strips respectively extend from the ends of the rear strip at an obtuse angle with respect to the rear strip to connect to both ends of the front strip.

13. The battery of claim 12, wherein the conductive compression layer comprises a second conductive compression layer conductively connecting the second electrode tab to the second electrode surface, the second conductive compression layer has a sheet shape with a contour following the second rim portion and covers a second accommodation space surrounded along its periphery by the second rim portion.

14. The battery of claim 13, wherein the second conductive compression layer has a round shape or a plurality of bends following the front strip of the second rim portion.

15. The battery of claim 1, wherein the rim portion of the electrode tab forms a single continuous accommodation space on the electrode surface.

16. The battery of claim 1, wherein the electrode tab further comprises a pattern portion extending inside the rim portion to form a plurality of accommodation spaces surrounded by the rim portion.

17. The battery of claim 16, wherein the electrode tab further comprises a protrusion portion extending from the rim portion on the electrode surface in a first direction to a position outside the electrode tab, and
wherein the pattern portion comprises a strip extending in one of the first direction and a second direction crossing the first direction and forms a plurality of accommodation spaces elongated in one of the first direction and the second direction.

18. The battery of claim 16, wherein the pattern portion comprises a plurality of strips extending in a first direction and a second direction crossing the first direction to form a plurality of accommodation spaces arranged in the first direction and the second direction.

19. The battery of claim 16, wherein the pattern portion comprises a plurality of strips between accommodation spaces formed in unit shapes, and
wherein uniform unit shapes forming the accommodation spaces are repeated in a first direction and a second direction crossing the first direction.

20. The battery of claim 19, wherein the plurality of strips forming the pattern portion are arranged alternately with the accommodation spaces formed in the unit shapes in the first direction and the second direction.

21. The battery of claim 19, wherein the unit shapes are spaced apart from a boundary of the electrode tab and the accommodation spaces are closed by the electrode tab, or
wherein the unit shapes contact the boundary of the electrode tab and the accommodation spaces are open to the outside of the electrode tab.

22. The battery of claim 19, wherein the unit shapes are arranged in rows in one of the first direction and the second direction, and
wherein the unit shapes of columns adjacent to each other in one of the second direction and the first direction are at the same position.

23. The battery of claim 19, wherein the unit shapes are arranged in rows in one of the first direction and the second direction, and
wherein the unit shapes of columns adjacent to each other in one of the second direction and the first direction are arranged at positions staggered from each other.
